(19) United States
(12) Patent Application Publication
(10) Pub. No.: US 2005/0182946 A1
(43) Pub. Date: Aug. 18, 2005

(54) Fast hashing function for pseudo-random generator

(76) Inventor: Will Shatford, Pasadena, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/056,308

(22) Filed: Feb. 11, 2005

Related U.S. Application Data
(60) Provisional application No. 60/544,652, filed on Feb. 13, 2004.

(51) Int. Cl. H04K 1/00

(52) U.S. Cl. 713/185; 380/28

(57) ABSTRACT

A method and computer device for generating a pseudo-random value string of N characters for an authentication token. The method partitions a message digest into at least one segment, each segment comprising a number of consecutive bits from the message digest, wherein the segments are consecutive when taken together, such that a first segment begins with the most significant bit and a last segment ends with the least significant bit. For each segment, the method converts the bits to a decimal value, and compares the decimal value to a set of satisfactory values, wherein each entry in the set includes a valid decimal value and a corresponding character representation. When the decimal value matches a valid decimal value in set of satisfactory values and the length of the pseudo-random value is less than N, the method appends the corresponding character representation of the decimal value to the pseudo- random value.

### CROSS-REFERENCE TO A RELATED APPLICATION

This application for letters patent is related to and incorporates by reference provisional application Ser. No. 60/544,652, titled “Fast Hashing Function for Pseudo-Random Generator,” and filed in the U.S. Pat. No. and Trademark Office on Feb. 13, 2004.

### FIELD OF THE INVENTION

The present invention relates, in general, to creation of an authentication token for a secure transaction. In particular, the present invention is a process for creating an authentication token that includes a pseudo-random value derived from a secure hashing function.

### BACKGROUND OF THE INVENTION

A secure hash function generates a hash value from an input string of text. The hash value, also known as a hash or a message digest, is substantially smaller than the text and is generated by a formula that makes it extremely unlikely that some other text will produce the same hash value. One type of hashing function produces a one-way signature. Since a one-way signature is not an encrypted form of the message, the message cannot be recreated by simply un-hashing the signature.

Hash values are useful to ensure that an individual cannot tamper with data stored in a computer, such as a general-purpose computer, unless such an -individual has the proper authorization. A sender generates a hash value for a message, combines the hash value and the message into an encrypted bundle, and sends the encrypted bundle to a recipient. The recipient decrypts the encrypted bundle, generates a hash value for the received message, and compares the generated hash value to the received hash value. If both hash values are the same, there is a very high probability that the message was transmitted intact.

Using a secure hash function, it is not computationally feasible to find a message that corresponds to a given hash value. It is also not computationally feasible to find two different messages that produce the same hash value. Any change to a message in transit will, with very high probability, result in a different hash value. With a secure hash function, even the smallest change to the message will have an unpredictable change in the hash value and a secure hash function will be extremely difficult to reverse-engineer by making repeated small changes to the message and observing the resulting signature.

For most hashing functions, the signature is the same size no matter how large (or small) the input string of text. For example, the Secure Hash Algorithm SHA-1, an algorithm certified for government use under the Federal Information Processing Standards (FIPS), always generates a 160-bit hash code of the input string. Similarly, the Message Digest algorithms MD4 and MD5 always generate a 128-bit hash code of the input string. Due to the length of these hash codes, the signature of the hashing functions can be easily transferred electronically, but it is not practical to manually enter the hash code into a paper or electronic form.

Thus, there is a need for a process for creating an authentication token that includes a pseudo-random value derived from a secure hashing function. The pseudo-random value is a shortened form of the hash function signature and will be difficult to predict because the signature of the secure hashing function is difficult to predict. The present invention addresses this need.

### SUMMARY OF THE INVENTION

The present invention teaches a method and computer device for generating a pseudo-random value string of N characters for an authentication token. The method partitions a message digest into at least one segment, each segment comprising a number of consecutive bits from the message digest, wherein the segments are consecutive when taken together, such that a first segment begins with the most significant bit and a last segment ends with the least significant bit. For each segment, the method converts the bits to a decimal value, and compares the decimal value to a set of satisfactory values, wherein each entry in the set includes a valid decimal value and a corresponding character representation. When the decimal value matches a valid decimal value in the set of satisfactory values and the length of the pseudo-random value is less than N, the method appends the corresponding character representation of the decimal value to the pseudo-random value.

Additional objects, advantages, and novel features of the invention will be set forth in part in the description, examples, and figures which follow, all of which are intended to be for illustrative purposes only, and not intended in any way to limit the invention, and in part will become apparent to the skilled in the art on examination of the following, or may be learned by practice of the invention.

### BRIEF DESCRIPTION OF THE DRAWINGS

The accompanying figures best illustrate the details of the process for creating an authentication token that includes a pseudo-random value derived from a secure hashing function. Reference numbers and designations that are alike in the accompanying figures refer to like elements.

FIG. 1 is a process flow diagram that illustrates an exemplary embodiment of the process for generating a pseudo-random value comprising digits.

FIG. 2 is a process flow diagram that illustrates an exemplary embodiment of the process for generating a pseudo-random value comprising alphanumeric characters in a lookup table.

### DETAILED DESCRIPTION OF THE INVENTION

Authentication is the process of identifying an individual, usually based on a username and password, to ensure that the individual is who he or she claims to be. In some secure computing systems, authentication is established using an authentication token, a small device that displays a code. The code is a random value that changes periodically (e.g., every 60 seconds). For a user to successfully log into a network requires the combination of the random value code displayed by the authentication token and a value known to the user (e.g., a user identifier). One such small device is the SecurnD manufactured by RSA Security, Inc.

The fast hashing function of the present invention operates in a computing system, such as a general-purpose computer, or a small electronic device, such as a smart card or integrated circuit card (ICC). The fast hashing function generates a pseudo-random value that can combine with a known value (e.g., a user identifier) to create an authentication code. Typically, the message string used to compute the pseudo-random generator is a date/time clock, an incrementing counter, standard geo-location information, a fixed parameter plus a variable parameter, or any combination thereof. Since the standard output from the hash function is a fixed length message digest, commonly 128-bits or 160-bits, the signature can be easily transferred electronically, but it is not practical to manually enter this long string into a paper or electronic form. The fast hashing function of the present invention combines the physical authentication token with a shortened form of the signature. The fast hashing function has been optimized for messages of constant length and designed to return a hash value string with a configurable length (at least 6 characters). The characters that comprise the string may be digits (e.g., the base-10 characters 0-9), or alphanumeric characters (e.g., the base-62 characters A-Z, a-z, and 0-9).

For authentication, using a much shorter message signature is faster and easier for the user, but it becomes a lot easier for an unauthorized user to guess the valid pseudo-random value by running through all the possible combinations. Combining the pseudo-random value with another value known only to the user maintains the simplicity, but minimizes unauthorized entry. Including intrusion detection in the authentication system can also minimize unauthorized entry. The system can be disabled for the user after a preset number of authentication failures within a preset period of time. In addition, the authentication messages (and therefore the message signature) can be reset for each authentication attempt. This makes it very difficult to guess the correct signature in a few attempts. The signature can be set to be valid for only one successful authentication. This makes it very difficult for the signature to be intercepted and used at anther time.

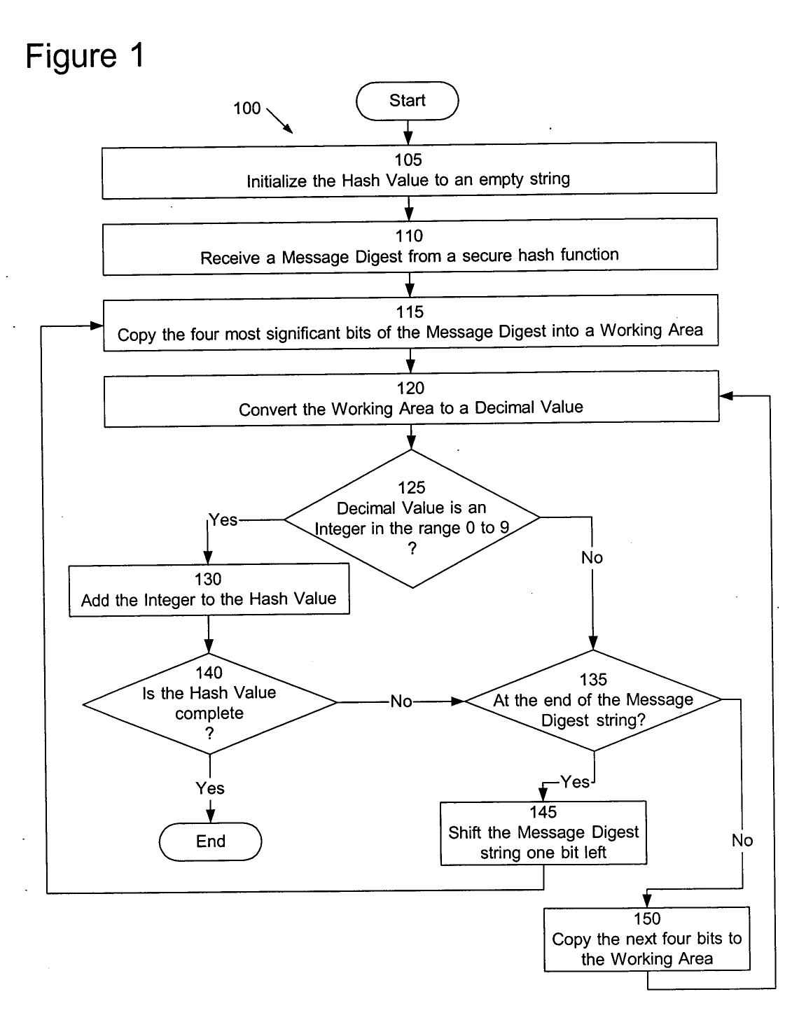

FIG. 1 illustrates an exemplary embodiment of the process for generating a pseudo-random value string of N characters comprising base-10 digits in the range of 0 to 9. The process 100 shown in FIG. 1 begins by initializing the hash value to an empty string (step 105). The process 100 receives a message digest from a secure hash function (step 110). The secure hash function includes SHA-1, MD4, MD5, a proprietary secure hash function, or other secure hash function that generates a message digest of any size (64-bits, 128-bits, 160-bits, etc.).

In one exemplary embodiment, the length of the message digest is 160-bits. Beginning with the most significant bits, the process 100 copies a 4-bit segment of the message digest to a working area (step 115) and converts the working area to a decimal value (step 120). The process 100 examines the decimal value to determine if it represents an integer in the range 0-9 (step 125). If the decimal value is an integer, the process 100 appends the character representation of the integer to the hash value string (step 130). If the length of the hash value string equals the configurable length (step 140), the process 100 is finished. If the length of the hash value string is less than the configurable length (step 140) or if the decimal value is not an integer (step 125), the process 100 determines whether the 4-bits copied to the working area were the last 4-bits in the message digest string (step 135). If this is not the end of the message digest string, the process 100 copies the next 4-bits into the working area (step 150) and continues iterating from the converting of the working area to a decimal value (step 120).

If process 100 reaches the end of the message digest string and the length of the hash value string is less than the configurable length (step 140), processing continues until the length of the hash value string equals the configurable length (step 140). In one embodiment, the message digest string is shifted 1-bit left (step 145), and the process 100 iterates from the copying of the most significant 4-bit segment of the message digest to the working area (step 115). In another embodiment, the process 100 alters the message digest string in some known way and continues processing the altered message digest string from the most significant bit to the least significant bit. Alteration of the message digest string includes incrementing a counter appended to the least significant bits of the message digest string, or recreating the message digest using the secure hash function.

The following example illustrates using the hash value string of length six characters, that the process 100, shown in FIG. 1, will extract from an exemplary message digest string. The exemplary 160-bit message digest string, and 4-bit counter appended to the least significant bit, is represented in hexadecimal (base-16) format as:
a9f5 9ce3 6a70 6816 aba3 e257 1785 0c26 c9cd 0d89 d

The following table illustrates the iterations required by the fast hashing process to produce a pseudo-random generator represented as a 6-character string of base-10 digits.

| Iteration Number | 4-bit Segment | Hash Value |
|---|---|---|
| 1 | a | “” |
| 2 | 9 | “9” |
| 3 | f | “9” |
| 4 | 5 | “95” |
| 5 | 9 | “959” |
| 6 | c | “959” |
| 7 | e | “959” |
| 8 | 3 | “9593” |
| 9 | 6 | “95936” |
| 10 | a | “95936” |
| 11 | 7 | “959367” |
| END | | |

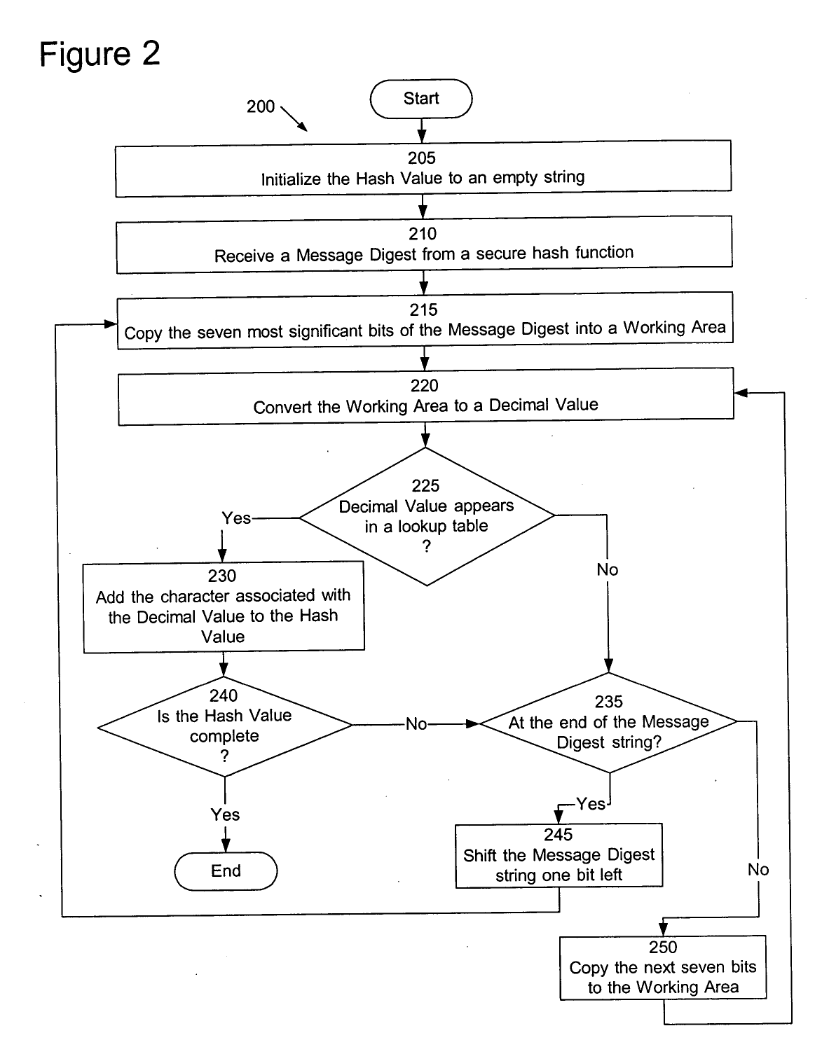

FIG. 2 illustrates an exemplary embodiment of the process for generating a pseudo-random value string of N characters, comprising alphanumeric characters in a lookup table. The process 200 shown in FIG. 2 begins by initializing the hash value to an empty string (step 205). The process 200 receives a message digest from a secure hash function (step 210). The secure hash function includes SHA-1, MD4, MD5, a proprietary secure hash function, or other secure hash function that generates a message digest of any size (64-bits, 128-bits, 160-bits, etc.).

In one exemplary embodiment, the length of the message digest is 160-bits. Beginning with the most significant bits, the process 200 copies a 7-bit segment of the message digest to a working area (step 215) and converts the working area to a decimal value (step 220). The process 200 examines a lookup table using the decimal value to determine if it represents an alphanumeric character (step 225). If the decimal value is an alphanumeric character, the process 200 appends the alphanumeric character to the hash value string (step 230). If the length of the hash value string equals the configurable length (step 240), the process 200 is finished. If the length of the hash value string is less than the configurable length (step 240) or if the decimal value is not an alphanumeric character (step 225), the process 200 determines whether the 7-bits copied to the working area were the last 7-bits in the message digest string (step 235). If this is not the end of the message digest string, the process 200 copies the next 7-bits into the working area (step 250) and continues iterating from the converting of the working area to a decimal value (step 220). If process 200 reaches the end of the message digest string and the length of the hash value string is less than the configurable length (step 240), processing continues until the length of the hash value string equals the configurable length (step 240).

In one embodiment, the message digest string is shifted 1-bit left (step 245), and the process 200 iterates from the copying of the most significant 7-bit segment of the message digest to the working area (step 215). In another embodiment, the process 200 alters the message digest string in some known way and continues processing the altered message digest string from the most significant bit to the least significant bit. Alteration of the message digest string includes incrementing a counter appended to the least significant bits of the message digest string, or recreating the message digest using the secure hash function.

The following example illustrates, using the hash value string of length six characters, that the process 200, shown in FIG. 2, will extract from an exemplary message digest string. The exemplary 160-bit message digest string, and 4-bit counter appended to the least significant bit, is represented in hexadecimal (base-16) format as: a9f5 9ce3 6a70 6816 aba3 e257 1785 0c26 c9cd 0d89 d

The exemplary 160-bit message digest string, and appended 4-bit counter, is represented in binary (base-2) format as:
a9f5 =1010 1001 1111 0101
9ce3 =1001 1100 1110 0011
6a70 =0110 1010 0111 0000
6816=0110 1000 0001 0110
aba3 =1010 1011 1010 0011
e257 =1110 0010 0101 0111
1785 =0001 0111 1000 0101
0c26 =0000 1100 0010 0110
c9cd =1100 1001 1100 1101
0d89 =0000 1101 1000 1001
d=1101

The following table illustrates iterations required by the fast hashing process 200 to produce a pseudo-random generator represented as a 6-character string of the base-62 alphanumeric characters A-Z, a-z, 0-9. For the example, as shown in the table below, the lookup table is used to convert from Decimal Value to Character in the American Standard Code for Information Interchange (ASCII) table. In another embodiment, the lookup table is modified to eliminate printable characters that may confuse a reader, that is, confusing the upper case 'O'with a zero digit 'O', or confusing a lower case 'L'with the numeric digit one '1'. In another embodiment, the lookup table is modified to provide a custom character set including a foreign alphabet, subset of an alphabet, printable characters, or the like. However, for the following example, the lookup table converts to base-62 alphanumeric characters A-Z, a-z, 0-9.

| Iteration | 7-bit | Decimal | | Hash |
|---|---|---|---|---|
| Number | Segment | Value | Character | Value |
| 1 | 1010 100 | 84 | ‘T’ | “T” |
| 2 | 1 1111 01 | 125 | ‘}’ | “T” |
| 3 | 01 1001 1 | 51 | ‘3’ | “T3” |
| 4 | 100 1110 | 78 | ‘N’ | “T3N” |
| 5 | 0011 011 | 27 | ESC | “T3N” |
| 6 | 0 1010 01 | 41 | ‘)’ | “T3N” |
| 7 | 11 0000 0 | 96 | ‘\grave{ }’ | “T3N” |
| 8 | 110 1000 | 104 | ‘h’ | “T3Nh” |
| 9 | 0001 011 | 11 | VT | “T3Nh” |
| 10 | 0 1010 10 | 42 | ‘*’ | “T3Nh” |
| 11 | 11 1010 0 | 116 | ‘t’ | “T3Nht” |
| 12 | 011 1110 | 62 | ‘>’ | “T3Nht” |
| 13 | 0010 010 | 18 | DC2 | “T3Nht” |
| 14 | 1 0111 00 | 92 | ‘\’ | “T3Nht” |
| 15 | 01 0111 1 | 47 | ‘/’ | “T3Nht” |
| 16 | 000 0101 | 5 | ENQ | “T3Nht” |
| 17 | 0000 110 | 6 | ACK | “T3Nht” |
| 18 | 0 0010 01 | 9 | TAB | “T3Nht” |
| 19 | 10 1100 1 | 89 | ‘Y’ | “T3NhtY” |
| END | | | | |

Although the disclosed embodiments describe a fully functioning process for creating an authentication token that includes a pseudo-random value derived from a secure hashing function, the reader should understand that other equivalent embodiments exist. Since numerous modifications and variations will occur to those reviewing this disclosure, the process for creating an authentication token that includes a pseudo-random value derived from a secure hashing function is not limited to the exact construction and operation illustrated and disclosed. Accordingly, this disclosure intends all suitable modifications and equivalents to fall within the scope of the claims.

1. A method for generating a pseudo-random value to create an authentication token that includes the pseudo-random value and a known value, the pseudo-random value comprising a string of N characters, comprising:
initializing the pseudo-random value to an empty string;
receiving a message digest having a most significant bit and a least significant bit;
partitioning the message digest into at least one segment, each segment comprising a number of consecutive bits from the message digest, wherein the segments are consecutive when taken together, such that a first segment begins with the most significant bit and a last segment ends with the least significant bit;
examining each segment sequentially beginning with the first segment and ending with the last segment;
converting each segment to a decimal value;
comparing the decimal value to a set of satisfactory values, each entry in the set including a valid decimal value and a corresponding character representation; and
appending the corresponding character representation of the decimal value to the pseudo- random value when the decimal value matches the valid decimal value for one entry in the set of satisfactory values, and the length of the pseudo-random value is less than N.

2. The method of claim 1, wherein the receiving of the message digest is from a secure hash function.

3. The method of claim 2, wherein the secure hash function is SHA-1, MD4, MD5, a proprietary secure hash function, or other secure hash function that generates a message digest of any size.

4. The method of claim 1, wherein the number of consecutive bits for each segment is 4.

5. The method of claim 4, wherein each valid decimal value in the set of satisfactory values is a one-digit integer.

6. The method of claim 1, wherein the number of consecutive bits for each segment is 7.

7. The method of claim 6, wherein each valid decimal value in the set of satisfactory values is an alphanumeric character.

8. The method of claim 1, further comprising:
creating an altered representation of the message digest, wherein the creating of the altered representation of the message digest follows completion of the examining, converting, comparing, and appending steps for the last segment, when the length of the pseudo-random value is less than N, and
wherein the processing of the altered representation of the message digest is the same as the processing of the message digest.

9. The method of claim 8, wherein the altered representation of the message digest includes a bit-shifted representation of the message digest, the message digest with a counter appended after the least significant bit after incrementing the counter, and a new message digest.

10. A computing device for generating a pseudo-random value to create an authentication token that includes the pseudo-random value and a known value, the pseudo-random value comprising a string of N characters, comprising:
a memory device; and
a processor disposed in communication with the memory device, the processor configured to:
initialize the pseudo-random value to an empty string;
receive a message digest having a most significant bit and a least significant bit;
partition the message digest into at least one segment, each segment comprising a number of consecutive bits from the message digest, wherein the segments are consecutive when taken together, such that a first segment begins with the most significant bit and a last segment ends with the least significant bit;
examine each segment sequentially beginning with the first segment and ending with the last segment;
convert each segment to a decimal value;
compare the decimal value to a set of satisfactory values, each entry in the set including a valid decimal value and a corresponding character representation; and
append the corresponding character representation of the decimal value to the pseudo-random value when the decimal value matches the valid decimal value for one entry in the set of satisfactory values, and the length of the pseudo-random value is less than N.

11. The computing device of claim 10, wherein the processor receives the message digest from a secure hash function.

12. The computing device of claim 11, wherein the secure hash function is SHA-1, MD4, MD5, a proprietary secure hash function, or other secure hash function that generates a message digest of any size.

13. The computing device of claim 10, wherein the number of consecutive bits for each segment is4.

14. The computing device of claim 13, wherein each valid decimal value in the set of satisfactory values is a one-digit integer.

15. The computing device of claim 10, wherein the number of consecutive bits for each segment is7.

16. The computing device of claim 15, wherein each valid decimal value in the set of satisfactory values is an alphanumeric character.

17. The computing device of claim 10, wherein the processor is further configured to:
create an altered representation of the message digest, wherein the creating of the altered representation of the message digest follows completion of the examining, converting, comparing, and appending steps for the last segment, when the length of the pseudo-random value is less than N, and
wherein the processing of the altered representation of the message digest is the same as the processing of the message digest.

18. The computing device of claim 17, wherein the altered representation of the message digest includes a bit-shifted representation of the message digest, the message digest with a counter appended after the least significant bit after incrementing the counter, and a new message digest.
